(19) United States
(12) Patent Application Publication
(10) Pub. No.: US 2012/0302283 A1
(43) Pub. Date: Nov. 29, 2012

(54) WIRELESS COMMUNICATION DEVICE AND PORTABLE ELECTRONIC DEVICE

(76) Inventor: Rong-Cheng Sun, New Taipei City (TW)

(21) Appl. No.: 13/236,669

(22) Filed: Sep. 20, 2011

(30) Foreign Application Priority Data
May 24, 2011 (TW) 100118088

(51) Int. Cl. H04W 88/02

(52) U.S. Cl. 455/552.1

(57) ABSTRACT

A wireless communication device for a portable electronic device includes a plurality of wireless communication modules for processing a wireless signal according to a plurality of communication protocols, an antenna module for transmitting and receiving the wireless signal, and a radio-frequency switch circuit for determining which one of the plurality of wireless communication modules is electrically connected to the antenna module according to a switching signal. A transmission frequency band of the antenna module and an operation frequency band of the radio-frequency switch circuit cover a plurality of transmission frequency bands of the plurality of wireless communication modules.

### BACKGROUND OF THE INVENTION

1. Field of the Invention

The present invention relates to a wireless communication device and portable electronic device, and more particularly, to a wireless communication device and portable electronic device capable of utilizing a radio-frequency switch to allow multiple wireless communication modules to share a same antenna.

2. Description of the Prior Art

As technology advances, portable electronic devices such as notebook computers, personal digital assistants (PDAs) and smart phones are now widely equipped with wireless communication modules and antennas to provide wireless communication functionalities. Since an antenna must be customized according to the communication protocol used, notebook computers now include various different antennas to accommodate different transmission requirements according to different communication protocols.

Please refer to FIG. 1, which is a schematic diagram of antennas 100, 110, 120 and their corresponding wireless communication modules 130, 140, 150 in a portable electronic device according to the prior art. The wireless communication modules 130, 140, and 150 are Long Term Evolution (LTE), Worldwide Interoperability for Microwave Access (WIMAX), and Global Positioning System (GPS) modules, and the antennas 100, 110, and 120 are optimized for LTE, WIMAX and GPS, respectively.

With the trend for smaller portable electronic devices, it has become increasingly challenging for multiple antennas to be placed within a single portable electronic device in circuit design. Therefore, how to integrate antennas within a portable electronic device has become a common goal in the industry.

### SUMMARY OF THE INVENTION

A primary objective of the invention is to provide a wireless communication device and a portable electronic device, wherein the portable electronic device is a notebook computer, a tablet computer, a mobile phone, or a portable electronic product.

The invention discloses a wireless communication device for a portable electronic device. The wireless communication device comprises a plurality of wireless communication modules, for processing a wireless signal according to a plurality of communication protocols; an antenna module, for receiving/transmitting the wireless signal; and a radio-frequency switch circuit, coupled between the plurality of wireless communication modules and the antenna module, for determining which one of the plurality of wireless communication modules is electrically connected to the antenna module according to a switching signal; wherein a transmission frequency band of the antenna module and an operation frequency band of the radio-frequency switch circuit cover a plurality of transmission frequency bands of the plurality of wireless communication modules.

The invention further discloses a portable electronic device. The portable electronic device comprises a system circuit, for implementing functionalities of the portable electronic device; and a wireless communication device for a portable electronic device, comprising a plurality of wireless communication modules, for processing a wireless signal according to a plurality of communication protocols; an antenna module, for receiving/transmitting the wireless signal; and a radio-frequency switch circuit, coupled between the plurality of wireless communication modules and the antenna module, for determining which one of the plurality of wireless communication modules is electrically connected to the antenna module according to a switching signal; wherein a transmission frequency band of the antenna module and an operation frequency band of the radio-frequency switch circuit cover a plurality of transmission frequency bands of the plurality of wireless communication modules.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of antennas and corresponding wireless communication modules of a portable electronic device according to the prior art.

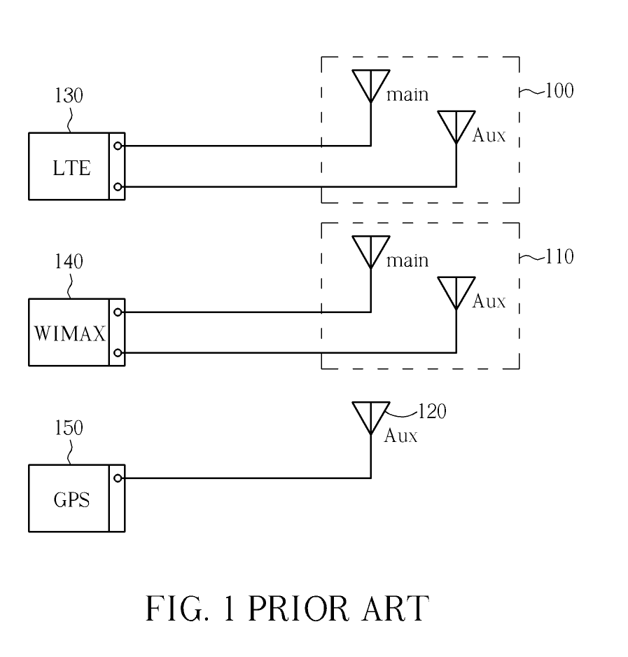

FIG. 2 is a schematic diagram of a wireless communication device of a portable electronic device according to an embodiment of the invention.

FIG. 3 is a schematic diagram of a primary switch module and an auxiliary switch module of the wireless communication device shown in FIG. 2.

### DETAILED DESCRIPTION

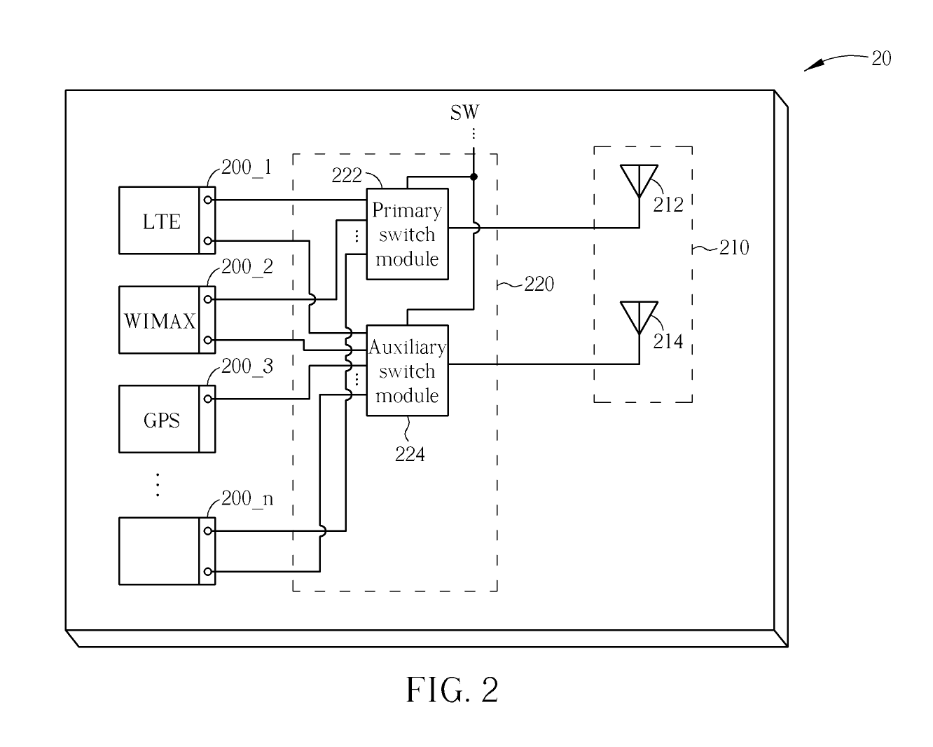

Please refer to FIG. 2, which is a schematic diagram of a wireless communication device 20 of a portable electronic device according to an embodiment of the invention. The wireless communication device 20 includes wireless communication modules 200_1-200_N, an antenna module 210, and a radio-frequency switch circuit 220. The antenna module 210 can receiving/transmit a wireless signal SS. Preferably, the wireless communication modules 200_1-200_N process the wireless signal SS according to Long Term Evolution (LTE), Worldwide Interoperability for Microwave Access (WIMAX), or Global Positioning System (GPS) communication protocols, respectively. The radio-frequency switch circuit 220 switches between the wireless communication modules 200_1-200_N according to a switching signal SW, such that only one wireless communication module is connected to the antenna module 210 at any time. Note that, since different communication protocols employ different frequency bands, a transmission frequency band of the antenna module 210 and an operation frequency band of the radio-frequency switch circuit 220 must cover transmission frequency bands of the wireless communication modules 200_1-200_N.

To eliminate the need for a portable electronic device to include multiple antennas to accommodate various communication protocols in the prior art, the wireless communication device 20 utilizes the radio-frequency switch circuit 220 to switch between wireless communication modules that are being used by the antenna module 210. In other words, since only one of the wireless communication modules 200_1-200_N is in operation at the same time, it is possible to utilize the radio-frequency switch circuit 220 to allow the wireless communication modules 200_1-200_N to share the same antenna module 210, thereby reducing the number of antennas required, as well as reducing manufacturing costs of the portable electronic device.

Moreover, according to “A communication device and a motherboard thereof” (ROC Patent Application Number 098134767), the radio-frequency switch circuit 220 may preferably be implemented with a Printed Circuit Board (PCB). As such, the wireless communication modules 200_1-200_N, the radio-frequency switch circuit 220 and the antenna module 210 may be integrated onto the same PCB, as shown in FIG. 2. This can greatly reduce development costs for the wireless communication device 20, and can especially reduce verification costs. Advancements in technology, e.g. Fourth Generation (4G) LTE, have given rise to higher verification costs for wireless communication devices. Integration of the wireless communication device 20 into the same PCB allows for a one-time verification, eliminating the need to separately verify modules and antennas implemented on different PCBs.

The radio-frequency switch circuit 220 may also be coupled to the wireless communication modules 200_1-200_N and the antenna module 210 via other media such as coaxial cable, Flexible Printed Circuit (FPC) cable.

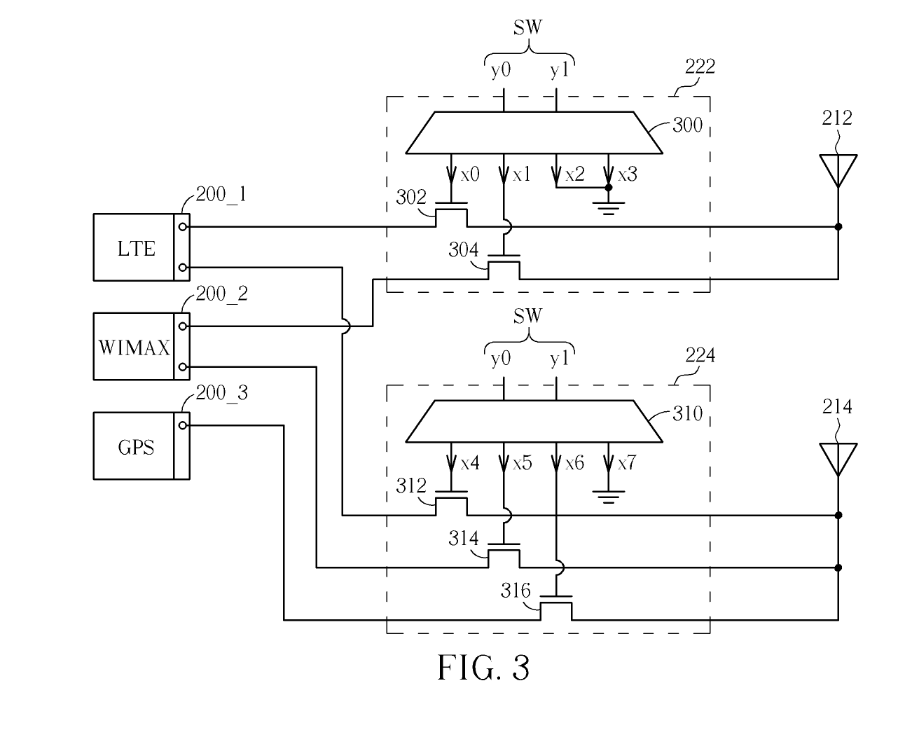

The antenna module 210 includes a primary antenna 212 and an auxiliary antenna 214 to conform to dual-antenna requirements of communication protocols such as LTE or WIMAX. Accordingly, the radio-frequency switch circuit 220 includes a primary switch module 222 and an auxiliary switch module 224, for switching connections from the primary antenna 212 and the auxiliary antenna 214 respectively, to the wireless communication modules 200_1-200_N. For example, please refer to FIG. 3, which is a schematic diagram of the primary switch module 222 and the auxiliary switch module 224. In FIG. 3, N equals 3, and the wireless communication modules 200_1-200_3 are LTE, WIMAX, and GPS communication modules, respectively. The primary switch module 222 includes a decoder 300 and switches 302, 304. The switch module 224 includes a decoder 310 and switches 312, 314, and 316. The decoders 300, 310 generate gate control signals x0, x1, x2, x3 and gate control signals x4, x5, x6, x7 according to digital values y0, y1 of the switching signal SW, respectively. The switches 302, 304 control whether the wireless communication modules 200_1-200_2 are connected to the primary antenna 212 according to the gate control signals x0, x1, respectively. Similarly, the switches 312, 314, 316 control whether the wireless communication modules 200_1-200_3 are connected to auxiliary antenna 214 according to the gate control signals x4, x5, x6, respectively. Decoding and switching operations of the decoders 300, 310 and the switches 302, 304, 312, 314, 316 are well known to those skilled in the art, and are not detailed here.

Note that, apart from PCB, antennas of the antenna module 210 can also be implemented with ceramic chip or bended metal, etc., but are not limited thereto. Furthermore, with the rapid growth in demands for wireless communication, various portable electronic devices such as notebook computers, tablets, smart phones and Personal Digital Assistants (PDAs) are now integrated with different communication protocol functionalities. Thus, the invention enables integration of different wireless communication functionalities into the same PCB, thereby reducing product development, verification, and fabrication costs.

In the prior art, in order to implement multiple communication protocol functionalities in a portable electronic device, a dedicated antenna is required for each of the different communication protocols. This leads to an excessive spatial volume, opposing requirements for a compact and light-weight design. Comparatively, the invention utilizes the radio-frequency switch circuit 220 to allow the wireless communication modules 200_1-200_N to share the same antenna module 210. This not only reduces the number of antennas, but also allows integration of different wireless communication protocol modules into a same PCB, thereby reducing spatial volume and development costs (especially verification costs).

In summary, the invention allows different wireless communication modules to share the same antenna module via a radio-frequency switch circuit, thereby reducing development and manufacturing costs.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A wireless communication device for a portable electronic device, comprising:
a plurality of wireless communication modules, for processing a wireless signal according to a plurality of communication protocols;
an antenna module, for receiving/transmitting the wireless signal; and
a radio-frequency switch circuit, coupled between the plurality of wireless communication modules and the antenna module, for determining which one of the plurality of wireless communication modules is electrically connected to the antenna module according to a switching signal;
wherein a transmission frequency band of the antenna module and an operation frequency band of the radio-frequency switch circuit cover a plurality of transmission frequency bands of the plurality of wireless communication modules.

2. The wireless communication device of claim 1, wherein the radio-frequency switch circuit is implemented with a Printed Circuit Board (PCB).

3. The wireless communication device of claim 2, wherein the radio-frequency switch circuit is coupled to the plurality of wireless communication modules and the antenna module via PCB, coaxial cables, or Flexible Printed Circuit (FPC) cables.

4. The wireless communication device of claim 1, wherein the plurality of wireless communication modules comprise a Long Term Evolution (LTE) communication module, a Worldwide Interoperability for Microwave Access (WIMAX) communication module, and a Global Positioning System (GPS) communication module.

5. The wireless communication device of claim 1, wherein the antenna module comprises:
a primary antenna, coupled to the radio-frequency switch circuit; and
an auxiliary antenna, coupled to the radio-frequency switch circuit.

6. The wireless communication device of claim 5, wherein the radio-frequency switch circuit comprises:
a primary switch module, comprising:
a first decoder, for decoding the switching signal to generate a plurality of first gate control signals; and
a plurality of first switches, each first switch coupled to a wireless communication module of the plurality of wireless communication modules, the first decoder and the primary antenna, for controlling the electrical connection from the wireless communication module to the primary antenna according to a first gate control signal of the plurality of first gate control signals; and
an auxiliary switch module, comprising:
a second decoder, for decoding the switching signal to generate a plurality of second gate control signals; and
a plurality of second switches, each second switch coupled to a wireless communication module of the plurality of wireless communication modules, the second decoder and the auxiliary antenna, for controlling an electrical connection from the wireless communication module to the auxiliary antenna according to a second gate control signal of the plurality of second gate control signals.

7. The wireless communication device of claim 1, wherein the antenna module comprises at least an antenna, and the antenna is implemented with PCB, ceramic chip or bended metal.

8. A portable electronic device, comprising:
a system circuit, for implementing functionalities of the portable electronic device; and
a wireless communication device for a portable electronic device, comprising:
a plurality of wireless communication modules, for processing a wireless signal according to a plurality of communication protocols;
an antenna module, for receiving/transmitting the wireless signal; and
a radio-frequency switch circuit, coupled between the plurality of wireless communication modules and the antenna module, for determining which one of the plurality of wireless communication modules is electrically connected to the antenna module according to a switching signal;
wherein a transmission frequency band of the antenna module and an operation frequency band of the radio-frequency switch circuit cover a plurality of transmission frequency bands of the plurality of wireless communication modules.

9. The portable electronic device of claim 8, wherein the radio-frequency switch circuit is implemented with a Printed Circuit Board (PCB).

10. The portable electronic device of claim 8, wherein the radio-frequency switch circuit is coupled to the plurality of wireless communication modules and the antenna module via PCB, coaxial cables, or Flexible Printed Circuit (FPC) cables.

11. The portable electronic device of claim 8, wherein the plurality of wireless communication modules comprise a Long Term Evolution (LTE) communication module, a Worldwide Interoperability for Microwave Access (WIMAX) communication module and a Global Positioning System (GPS) communication module.

12. The portable electronic device of claim 8, wherein the antenna module comprises:
a primary antenna, coupled to the radio-frequency switch circuit; and
an auxiliary antenna, coupled to the radio-frequency switch circuit.

13. The portable electronic device of claim 12, wherein the radio-frequency switch circuit comprises:
a primary switch module, comprising:
a first decoder, for decoding the switching signal to generate a plurality of first gate control signals; and
a plurality of first switches, each first switch coupled to a wireless communication module of the plurality of wireless communication modules, the first decoder and the primary antenna, for controlling an electrical connection from the wireless communication module to the primary antenna according to a first gate control signal of the plurality of first gate control signals; and
an auxiliary switch module, comprising:
a second decoder, for decoding the switching signal to generate a plurality of second gate control signals; and
a plurality of second switches, each second switch coupled to a wireless communication module of the plurality of wireless communication modules, the second decoder and the auxiliary antenna, for controlling an electrical connection from the wireless communication module to the auxiliary antenna according to a second gate control signal of the plurality of second gate control signals.

14. The portable electronic device of claim 8, wherein the antenna module comprises at least an antenna, and the antenna is implemented with PCB, ceramic chip or bended metal.
